(19) United States
(12) Patent Application Publication
(10) Pub. No.: US 2005/0197746 A1
(43) Pub. Date: Sep. 8, 2005

(54) Method for controlling driving stability of a vehicle

(76) Inventors: Christoph Pelchen, Tettnang (DE); Martin Munster, Wilhelmsdorf (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/042,596

(22) Filed: Jan. 24, 2005

(30) Foreign Application Priority Data
Jan. 29, 2004 (DE) 10 2004 004 336.1

(51) Int. Cl. G06F 17/00

(52) U.S. Cl. 701/1; 340/440

(57) ABSTRACT

A method for controlling the driving stability of a vehicle comprising the steps of determining whether or not a curved path lies before the vehicle, if a curved driving path found to exist; determining the probable uncorrected “inherent” path (B), determining the specified “set” path (S), a comparison of the inherent path (B) and the set path (S) and determination of a deviation (x) in the controlled path taken; determining the distribution of a roll moment (ERCₖ) for at least a partial compensation of the deviation (x) from the path; realization of the determined roll moment distribution (ERCₖ) by the issuing of position signals (SMVA, SMHA) to a forward active stabilizer (2) for the changing of a forward support moment (MVA).

The invention concerns a method for controlling the driving stability of a vehicle.

For the control of driving stability, where lateral forces exert themselves on a vehicle, which forces can normally occur upon driving in a curved path, it is a known practice to installed stabilizers, which can compensate for a tendency to roll. For this purpose, as a rule, both vehicle axles are equipped with active stabilizers and the counter-roll moment and the support moment are apportioned on both axles to be constantly or even partially controlled by simple measures.

In the case of driving in a curved path, the driver must follow the given course of the curve the degree of which the driver is not able to completely estimate. Especially when a turning path has a changing radius of curvature, the steering wheel angle must be corrected whereby opportunities for imprecise reaction and instabilities in the dynamics of movement of the vehicle can occur.

With this background, the purpose of the invention is to create a method for the control of the driving stability of a vehicle which, in critical situations of driving in curves, assures a high degree of driving safety along with ease of driving and further a considerable amount of travel comfort is provided.

The achievement of this purpose can be inferred from the features of the principal claim, while advantageous embodiments and developments of the invention are to be found in the subordinate claims.

The concept of the invention is to be found in the fact that with a changing of the apportionment of the roll support moments, i.e., the apportionment of the roll moment distribution, a corresponding change of the inherent steering effect of the vehicle is also effected. In this way, it is possible that by means of a change of the roll moment distribution, an additional steering mode is brought about by means of which the driving in a curved manner can be stabilized. By means of locating the roll support on the rear axle, in this way, the vehicle turning is reinforced without a necessity of the driver increasing the angle of turn of the steering wheel. This situation is also valid in reverse order.

According to the invention, in this way, first, by way of an appropriate control of the active stabilizers, a change of the turning radius of a road curve is compensated for, either partly or completely. In simple cases, the driver can enter the curve with a starting turn of the steering wheel and, where only small changes in the radius of curvature exist, for instance in a case of a tightening curve, no steering corrections are needed. In case no exceptionally severe changes of the radius of curvature are present, the variations of said curvature can be directly compensated for by a control apparatus in accordance with the invented method for the driving stability of a vehicle without coming to the attention of the driver.

In this way, a dynamic roll moment apportionment is used according to the invention. This can be carried out, fundamentally, also by a dynamic changing of only the forward or only the rear support moment. Advantageously, however, the stabilizers on the forward axle, as well as on the rear axle, are made to dynamically react.

Besides or in addition to, a compensation of changes in the radius of curvature, also a compensation of the roll apportionment can be brought about by changes of the steering wheel angle, especially by undertaking short, quick movements of the steering wheel so that a smooth, but still dynamic, riding comfort can be maintained.

For the clarification of the invention, a drawing accompanies this description. There is shown in:

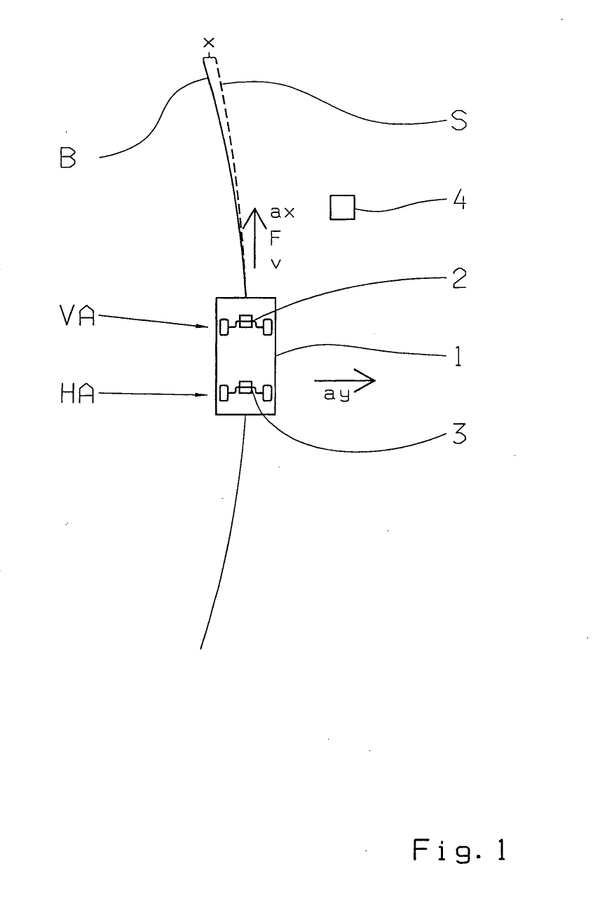

FIG. 1 is a schematic diagram of a vehicle driving in a curved path;

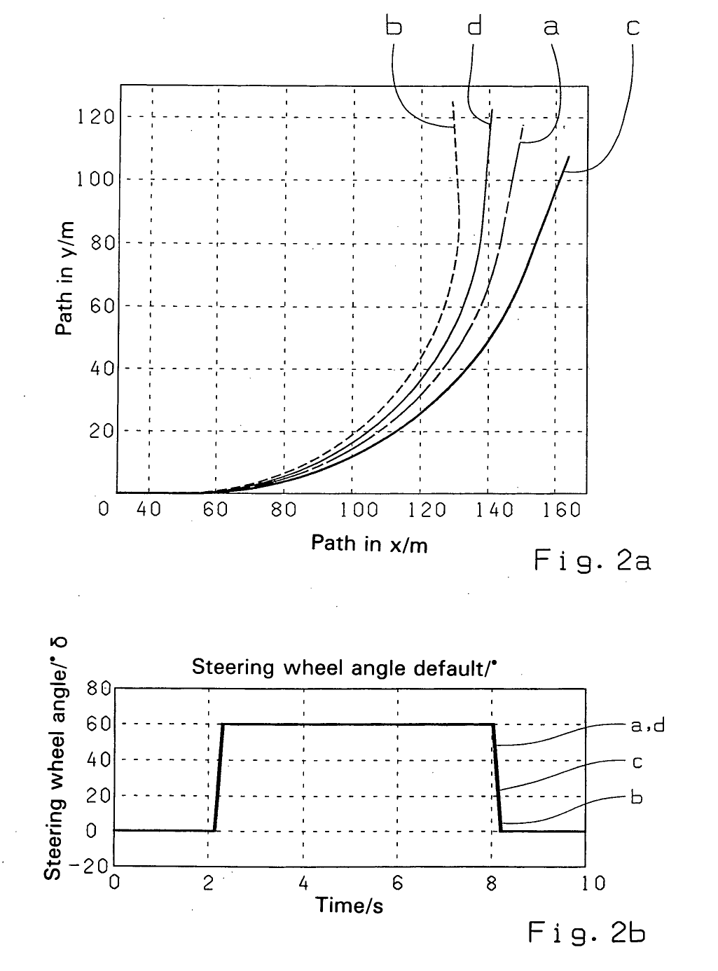

FIG. 2a is a graph presenting curved path driving showing effect of various roll apportioning;

FIG. 2b is a graph presenting a steering wheel angular displacement in relation to the time for the curves of FIG. 2a; and

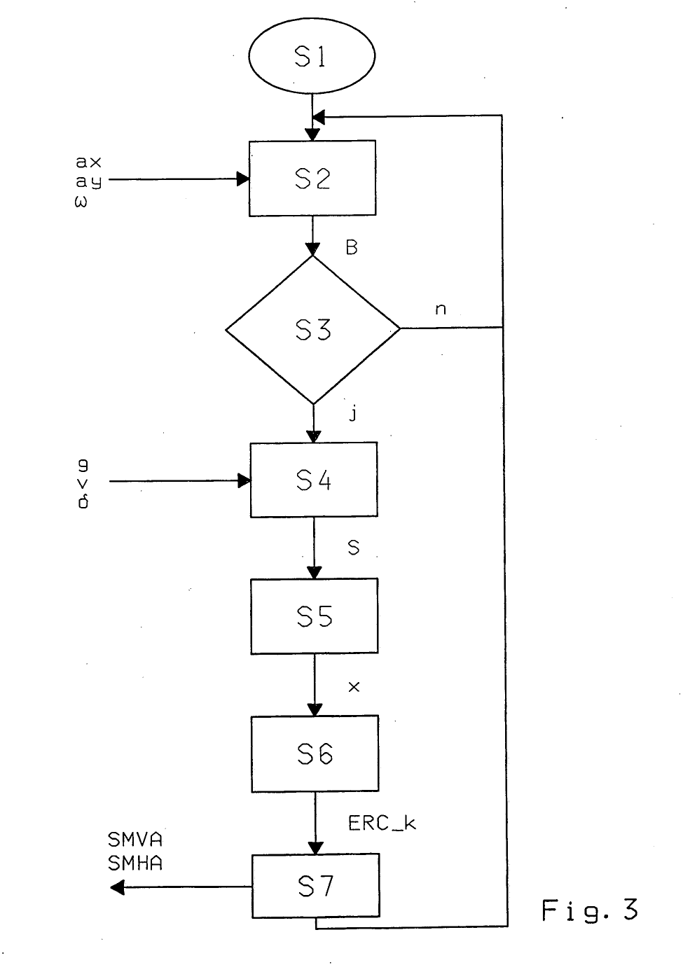

FIG. 3 is a flow chart of an invented method according to one embodiment of the invention.

A vehicle 1 drives in a travel direction F upon an inherent path B. The vehicle possesses on its forward axle VA a forward active stabilizer 2 and on its rear axle, correspondingly a rear active stabilizer 3 with which stabilizers a forward support moment MVA and a rear support moment MHA are exerted, in order that upon a curved driving path, because of the transverse acceleration ay, the inertially caused roll moment can be actively compensated.

The inherent curved driving path B of the vehicle 1 can deviate from an existing set path S defined by the curvature of the given road by a difference, designated as deviation x. The deviation x, for the purpose here, can be defined as the difference of the radii of the inherent path B and the existing set path S. The deviation x is normally corrected by the driver by an adjustment of the angle of the steering wheel in the amount of δ angular units.

According to the invention, as an additional possibility for the so mentioned correction or compensation of the deviation x, provision is made that a roll moment apportionment ERCₖ is changed, which reflects the quotient of MVA to the sum of MHA and MVA, this, being expressed differently, is:

$${ERC}_{k} = \frac{MVA}{\vert MVA \vert + \vert MHA \vert}$$

The effect of such a change of the roll moment apportioning, ERCₖ is shown in FIG. 2a, b by a series of curves for respectively different vehicles. That is to say, for the respectively different driving stability controls. FIG. 2a shows the respective curve of the path in a Cartesian manner, where identical steering wheel angular positions are maintained and the abscissae represent displacement in longitudinal length units per meter and the ordinates represent the transverse displacement in length units per meter.

FIG. 2b demonstrates the time related behavior of the of the steering wheel angular displacement δ for the following conditions:
a passive roll support
b ERCₖ=0.6
c ERCₖ=1.0
d ERCₖ=dynamic roll moment apportionment

In spite of identical steering wheel angular specifications for all variants a to d, the vehicles turned in different curvatures, as may be see from the graph of FIG. 2a. That vehicle designated as showing a dynamic roll moment apportionment, namely ERCₖ on curve d can serve as a reference point, which vehicle follows essentially a 90° curve.

Contrarily thereto, the passive vehicle without active stabilizers 2, 3 executes a curve with a greater radius of curvature and, in accord with this, must be more strongly steered so that it can follow the existing curvature of the road, which has been defined by said reference vehicle of the curve d as a set curve S.

The deviation is reinforced by under-steering in the case of the forward axle, as the curve c for the vehicle solely equipped with the 100% forward axle engagement.

By increasing the roll support on the rear axle HA, for example by means of 60/40 apportionment, where ERCₖ=0.6, the vehicle steers itself more intensively into the turn and carries out a more narrow path. Accordingly, it would be possible for the driver to lessen the angle of departure of the steering wheel in order to follow the curve d. Constantly strong, rear axle roll moment apportionments are, however, dangerous since the inherent steering, in accord with the apportionment factor and the radius of curvature, results sooner or later in over-steering and the vehicle can, on this account, be forced into a laterally directed skid. This effect can occur by the shown driving maneuver at a 50/50 apportionment and is safely prevented, according to the invention, by a dynamic roll moment apportionment, which does not reflect itself on the position of the steering wheel.

The curves a to d show that, due to the invented method, the actuality of the steering wheel attention provided by the driver can be changed. In cases of given travel courses, this leads to different intensive requirements for steering wheel intervention. By way of a dynamic roll moment apportion, it is further possible, even during the maneuver, to change the additional inherent steering. In this way, the vehicle 1 can fundamentally follow the set path S with a different radius, without the driver being made aware of this and making unnecessary steering corrections. There exists, however, an upper and a lower threshold value for the ERCₖ in order to avoid under and over steering and not contrarily invade such steering ranges into which, without doubt, it becomes necessary for the driver to enter with intuitive corrections of the steering wheel angle.

Furthermore, maintaining a constant angle of steering for varying radii of curvature, according to the invention, it is further possible that even steering errors, for instance caused by the driver, which do not represent the actual conditions of the curve of the road, can be compensations made by the ERCₖ.

In FIG. 3 is presented a flow diagram of an embodiment of an invented method. After the start in step S1, in step S2 the inherent, curved course B is determined and checked in step S3 as to whether or not a curved path actually lies ahead of the vehicle. For the determination of the inherent path B, one or more movement values can be measured, for example, a longitudinal acceleration ax and or a transverse acceleration ay and/or a yaw tendency ω.

In case that step S3 determines that a curved path does indeed lie ahead, then in step S4 a set curved course is established. In this case, the set course can be influenced by the action of the driver, for instance, a steering wheel angular setting of δ and/or therefrom evoked rotation speed of achieving an angle, namely d δ/dt and/or a traveling speed g. In another manner, the set curve can be determined by the influence of wide-scanning sensors, such as optical sensors and/or ultrasonic devices or perhaps radar equipment, any of which measure distance to obstacles 4 beside the road or detect other objects in the path of traffic.

In step S5, the longitudinal path deviation is determined as the difference between the radii of the set course S and the current statement of the inherent curvature B. Therefrom in step S6, the roll moment apportionment ERCₖ is determined and in step S7, the characteristic signals SMVA, SMHA for the support moments MVA, MHA are established for the active stabilizers 2 and 3.

### REFERENCE NUMERALS

1 vehicle
2 forward active stabilizer
3 rear active stabilizer
4 obstacle
B inherent path within expected curvature
ERCₖ apportionment of roll moment
F direction of travel
HA rear axle
S set path within curvature
VA forward axle
MVA forward support moment
MHA rear support moment
SMVA positioning signal for forward support movement
SMHA positioning signal for rear support movement
ax longitudinal acceleration
ay transverse acceleration
a curve with passive roll support
b curve with ERCₖ=0.6
c curve with ERCₖ=1.0
d curve with ERCₖ=dynamic roll moment apportionment
g gas pedal position
v speed of travel
x deviation of curve
δ angular setting of steering wheel
ω amount of yaw

1-9. (canceled)

10. A method for controlling a driving stability of a vehicle comprising at least the following steps:
determining whether or not curved driving is present before the vehicle, and if a curved driving path is being approached by the vehicle then;
determining a probable inherent path of the vehicle (B);
determining a preferred and controllable set path (S);
comparing the inherent path (B) and the set path (S);
determining a deviation (x) in the controlled path taken;
determining apportionment of a roll moment apportionment (ERCₖ) for at least a partial compensation of the deviation (x);
actuating the determined roll moment apportionment (ERCₖ) by issuing position signals (SMVA, SMHA) to a forward active stabilizer (2) for changing of one of a forward support moment (MVA) and a rear active stabilizer (3) for changing of a rear support moment (MHA); and
determining a travel radius which is too small for the inherent path (B) as compared to the set path (S), the forward support moment (MVA), relative to the rear support moment (MHA) becomes larger, and upon the determination of a path radius of the inherent path (B) as being too large, compared to the set path (S), the forward support moment (MVA) relative to the rear support moment (MHA) is increased to a lesser degree.

11. The method for controlling the driving stability of a vehicle according to claim 10, further comprising the step of executing a control, based upon a constant radius of curvature, and altering the roll moment apportionment ERCₖ in such a manner that the vehicle follows the existing curve therebefore without any changing in the angle of the steering wheel.

12. The method according to claim 10, further comprising the step of only partially compensating for a deviation from a course by a change of the roll momentum apportionment (ERCₖ).

13. The method according to claim 10, further comprising the step of changing the roll moment apportionment (ERCₖ) only within a specified range of values.

14. The method according to claim 10, further comprising the step of compensating for changes made by a driver instigated steering wheel angularity (δ) with a lower and an upper threshold by changing the roll moment apportionment (ERCₖ).

15. The method according to claim 10, further comprising the step of determining the set path (S) with inclusion of one or more of the following driver associated values: an angle of positioning of a steering wheel (δ), a speed of turning of the steering wheel (dδ/dt), a speed of travel (v) and a gas pedal position (g).

16. The method according to claim 10, further comprising the step of determining the inherent path (B) with inclusion of one or more of the following measured values of motion: a longitudinal acceleration (ax), a transverse acceleration (ay), and a rate of skew (ω).

17. The method according to claim 10, further comprising the step of determining the inherent path (B) with inclusion of wide field scanning sensors in which the wide field scanning sensors comprise one or more of the following: optical sensors, ultrasonic sensors and radar sensors.

18. The method according to claim 17, further comprising the step of employing, as guidance values for spatial distances, at least one of the following: minimal distances, roadway limitations, other traffic participants and traffic obstructions (4).
